(19) United States
(12) Patent Application Publication
(10) Pub. No.: US 2010/0165035 A1
(43) Pub. Date: Jul. 1, 2010

(54) DISCHARGE INSPECTION APPARATUS, FLUID DISCHARGING APPARATUS, AND METHOD FOR WORKING SHIELD CABLE

(75) Inventor: Shinya KOMATSU, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/635,970

(22) Filed: Dec. 11, 2009

(30) Foreign Application Priority Data
Dec. 26, 2008 (JP) 2008-332605

(51) Int. Cl. B41J 29/393

(52) U.S. Cl. 347/19

(57) ABSTRACT

A discharge inspection apparatus inspects a fluid discharge state of a discharging head by applying a voltage. The discharging head discharges fluid from nozzles onto a target. The discharge inspection apparatus includes a detecting unit and a shield cable. The detecting unit detects an electric change that occurs when the fluid is discharged. The shield cable includes a first conductor, an insulating layer, a conductive layer, a second conductor, and a cover layer. A first voltage is applied to the first conductor. The conductive layer is positioned on an outer surface of the insulating layer, which covers the first conductor. The second conductor is positioned on an outer surface of the conductive layer and is covered by the cover layer. A second, lower voltage is applied to the second conductor. The shield cable is connected to at least either the detecting unit or the discharging head.

### BACKGROUND

1. Technical Field

The present invention relates to a discharge inspection apparatus, a fluid discharging apparatus, and a method for working a shield cable.

2. Related Art

A discharge inspection apparatus that has the following configuration and conducts nozzle inspection as follows has been proposed in the art. A voltage generation circuit and a voltage detection circuit are connected to a print head. The print head ejects ink from a plurality of nozzles. A detection electrode is provided on an ink absorber, which absorbs ink. A potential difference is generated between the detection electrode and the print head. The discharge inspection apparatus detects a change in voltage between the detection electrode and the print head so as to inspect whether ink is ejected from the nozzles or not. An example of such a discharge inspection apparatus is disclosed in, for example, JP-A-2008-23886. The related-art discharge inspection apparatus disclosed in JP-A-2008-23886 can judge whether ink is ejected from the nozzles or not by discharging ink with a voltage being applied to the print head. Therefore, the disclosed discharge inspection apparatus is capable of conducting discharge inspection for the plurality of nozzles in a short period of time.

However, the related-art discharge inspection apparatus disclosed in JP-A-2008-23886 has the following disadvantage. For example, electrostatic discharge or the like could occur inside a cable that is connected to the print head to which a voltage is applied at one cable end and is connected to the voltage detection circuit (including the voltage generation circuit) at the other cable end depending on the connection state of the cable. The electrostatic discharge causes noise, which makes it impossible or difficult to conduct ink-discharge inspection accurately. Therefore, there is a demand for a discharge inspection technique that makes it possible to conduct ink-discharge inspection with high inspection accuracy.

### SUMMARY

An advantage of some aspects of the invention is to provide a discharge inspection apparatus that is capable of conducting fluid discharge inspection with high inspection accuracy. The invention further provides, as an advantage of some aspects thereof, a fluid discharging apparatus and a method for working a shield cable.

In order to address the above-identified problems without any limitation thereto, the invention adopts any of the following novel and inventive configurations and features.

A discharge inspection apparatus according to a first aspect of the invention has the following features. The discharge inspection apparatus inspects a fluid discharge state of a discharging head through application of a voltage. The discharging head includes a plurality of nozzles. The discharging head discharges fluid from the nozzles onto a target. The discharge inspection apparatus includes a detecting section and a shield cable. The detecting section detects an electric change that occurs when the fluid is discharged from the discharging head. The shield cable includes a first conductor, an insulating layer, a conductive layer, a second conductor, and a cover layer. The first conductor is made of metal. A first voltage is applied to the first conductor. The insulating layer substantially covers the first conductor. The conductive layer, which has conductivity, is provided on an outer surface of the insulating layer. The second conductor is made of metal. The second conductor is provided on an outer surface of the conductive layer. A second voltage is applied to the second conductor. The second voltage is lower in level than the first voltage. The cover layer is provided on an outer surface of the second conductor. The conductive layer measured from an end of the cover layer in a direction of the length of the cable is longer than a separation portion, which is an exposed part of the second conductor where the cover layer does not cover the second conductor. The shield cable is connected to at least either the detecting section or the discharging head.

In the structure of a discharge inspection apparatus according to the first aspect of the invention, the conductive layer is provided between the second conductor and the insulating layer. With such a structure, for example, static electricity that is generated at the second conductor can be quickly removed by means of the conductive layer. Therefore, it is possible to suppress inner noise that occurs inside the cable. In addition, the part of the conductive layer measured from the end of the cover layer is longer than the separation portion, which is an exposed part of the second conductor where the cover layer does not cover the second conductor, as measured in the direction of the length of the cable. Therefore, the conductive layer having such a greater length absorbs electrostatic discharge, which would be generated if the exposed second conductor and the insulating layer covering the first conductor were provided opposite each other, thereby achieving discharge suppression. Since noise is suppressed, fluid discharge inspection can be conducted with high inspection accuracy. The conductive layer may be made of a material that has excellent adherence to the insulating layer. The adherence to the insulating layer may be greater than that to a metal conductor. It is preferable that the conductive layer should be made of conductive resin. The second conductor may be connected to a ground. That is, the level of the second voltage may be a ground level.

In the configuration of a discharge inspection apparatus according to the first aspect of the invention, it is preferable that the shield cable should be a coaxial cable whose central axis is the first conductor. In the structure of the coaxial cable, the insulating layer, the conductive layer, the second conductor, and the cover layer are formed around the first conductor in the order of appearance herein as viewed toward the outer circumference of the shield cable. Since noise is suppressed in the coaxial cable, fluid discharge inspection can be conducted with high inspection accuracy.

In the configuration of a discharge inspection apparatus according to the first aspect of the invention, it is preferable that the detecting section should include an amplifying circuit that amplifies the electric change and that the electric change that occurs when the fluid is discharged should be communicated through the shield cable. With such a preferred configuration, it is possible to suppress noise amplification that occurs due to the amplification of an electric change. Thus, fluid discharge inspection is conducted with high inspection accuracy.

In the configuration of a discharge inspection apparatus according to the first aspect of the invention, it is preferable that an insulator formation layer should be provided on a part of the second conductor that extends from the separation portion. With such a preferred structure, the exposed conductive layer can be shortened. Therefore, it is possible to suppress noise that could occur at the exposed second conductor, thereby conducting fluid discharge inspection with high inspection accuracy. In the structure of the shield cable, the second conductor may be cut at an end of the separation portion.

In the configuration of a discharge inspection apparatus according to the first aspect of the invention, it is preferable that the detecting section should include a fluid reception area where the fluid discharged from the discharging head is received; the detecting section should detect the electric change that occurs due to landing of the discharged fluid on the fluid reception area so as to detect the fluid discharge state on the basis of the result of detection of the electric change; the shield cable should be connected to the fluid reception area; the first voltage should be applied to the fluid reception area through the shield cable; and the electric change at the fluid reception area should be communicated through the shield cable. With such a preferred configuration, since the detecting section detects the electric change that occurs due to the landing of the discharged fluid on the fluid reception area, it is possible to conduct discharge inspection easily. In the configuration of a discharge inspection apparatus according to the first aspect of the invention, it is preferable that the detecting section should include a detecting member that is provided in a neighborhood of a position where the fluid discharged from the discharging head passes; the detecting section should detect the electric change that occurs when the discharged fluid passes through the position near the detecting member so as to detect the fluid discharge state on the basis of the result of detection of the electric change; the shield cable should be connected to the detecting member; the first voltage should be applied to the detecting member through the shield cable; and the electric change detected by the detecting member should be communicated through the shield cable. With such a preferred configuration, since the detecting member detects the electric change that occurs when the fluid passes through the neighborhood of the detecting member, it is possible to conduct nozzle inspection with comparative ease. In the configuration of a discharge inspection apparatus according to the first aspect of the invention, the length of a relatively long part of the conductive layer, which is measured from an end of the second conductor in the direction of the length of the cable, may be 3 mm or greater.

A fluid discharging apparatus according to a second aspect of the invention includes a discharge inspection apparatus according to the first aspect of the invention, or any of discharge inspection apparatuses having the preferred configuration and/or structure described above, and a discharging head that discharges the fluid. A discharge inspection apparatus according to the first aspect of the invention is capable of conducting fluid discharge inspection with high inspection accuracy. Therefore, a fluid discharging apparatus according to the second aspect of the invention, which is provided with such a discharge inspection apparatus, offers the same advantages as above.

A method for working a shield cable is also provided as a third aspect of the invention. The shield cable includes a first conductor, an insulating layer, a conductive layer, a second conductor, and a cover layer. The first conductor is made of metal. A first voltage is applied to the first conductor. The insulating layer substantially covers the first conductor. The conductive layer, which has conductivity, is provided on an outer surface of the insulating layer. The second conductor is made of metal. The second conductor is provided on an outer surface of the conductive layer. A second voltage is applied to the second conductor. The second voltage is lower in level than the first voltage. The cover layer is provided on an outer surface of the second conductor. The shield cable is connected to a discharge inspection apparatus for inspecting a fluid discharge state of a discharging head through application of a voltage. The discharging head includes a plurality of nozzles and discharges fluid from the nozzles onto a target. The discharge inspection apparatus conducts inspection by detecting an electric change that occurs when the fluid is discharged. The method for working a shield cable according to the third aspect of the invention includes: partially removing the cover layer from a front end region of the shield cable; and partially removing the conductive layer from the front end region of the shield cable. The cover layer and the conductive layer are partially removed in such a manner that the conductive layer measured from an end of the cover layer in a direction of the length of the cable is longer than a separation portion, which is an exposed part of the second conductor where the cover layer does not cover the second conductor.

In a method for working a shield cable according to the third aspect of the invention, the part of the conductive layer measured from the end of the cover layer is longer than the separation portion, which is an exposed part of the second conductor where the cover layer does not cover the second conductor, as measured in the direction of the length of the cable. Therefore, the conductive layer having such a greater length absorbs electrostatic discharge, which would be generated if the exposed second conductor and the insulating layer covering the first conductor were provided opposite each other, thereby achieving discharge suppression. In the structure of the shield cable, the conductive layer is provided between the second conductor and the insulating layer. With such a structure, for example, static electricity that is generated at the second conductor can be quickly removed by means of the conductive layer. Therefore, it is possible to suppress inner noise that occurs inside the cable. Since noise is suppressed, fluid discharge inspection can be conducted with high inspection accuracy. The various preferred features of a discharge inspection apparatus according to the first aspect of the invention may be added to a method for working a shield cable according to the third aspect of the invention.

### BRIEF DESCRIPTION OF THE DRAWINGS

The invention will be described with reference to the accompanying drawings, wherein like numbers reference like elements.

FIG. 1 is a diagram that schematically illustrates an example of the configuration of a printer according to an exemplary embodiment of the invention.

FIG. 2 is a perspective view that schematically illustrates an example of the configuration of a nozzle inspection device according to an exemplary embodiment of the invention.

FIG. 3 is a block diagram that schematically illustrates an example of the configuration of the nozzle inspection device according to an exemplary embodiment of the invention.

FIG. 4 is a diagram that schematically illustrates an example of the structure of one end region of a shield cable according to an exemplary embodiment of the invention.

FIG. 5 is a diagram that schematically illustrates an example of the structure of the other end region of the shield cable according to an exemplary embodiment of the invention.

FIG. 6 is a diagram that schematically illustrates an example of the working of an end region of the shield cable according to an exemplary embodiment of the invention.

FIG. 7 is a diagram that schematically illustrates an example of the structure of a shield cable that includes a conductive resin layer that is shorter than a peripheral conductor.

FIG. 8 is a diagram that schematically illustrates an example of the structure of a shield cable according to a modification example of the invention that includes a conductive resin layer whose length is equal to that of an insulating layer.

FIG. 9 is a block diagram that schematically illustrates an example of the configuration of a nozzle inspection device according to a modification example of the invention.

### DESCRIPTION OF EXEMPLARY EMBODIMENTS

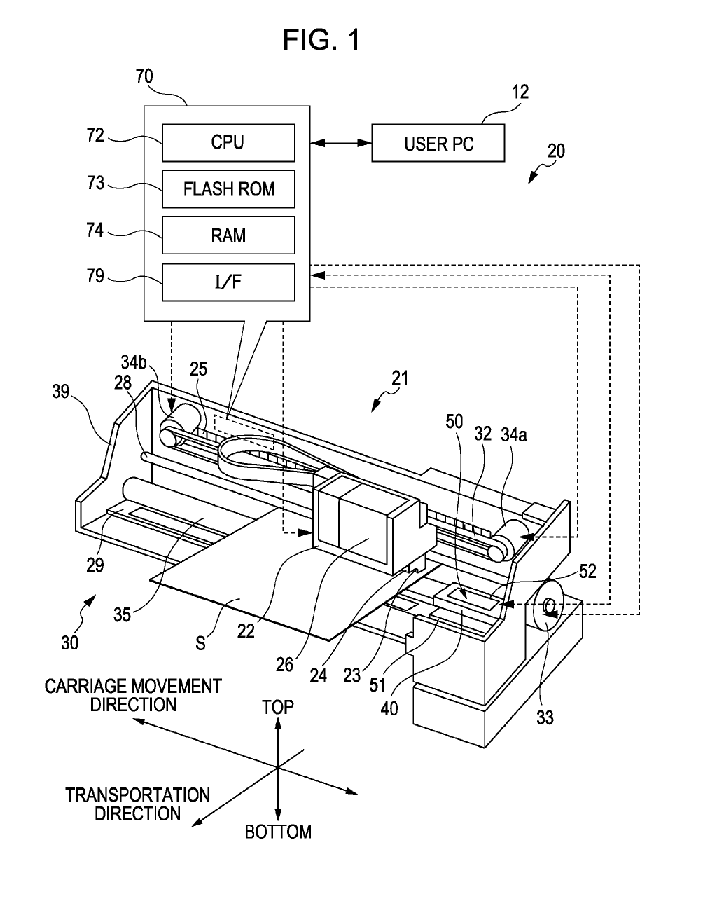

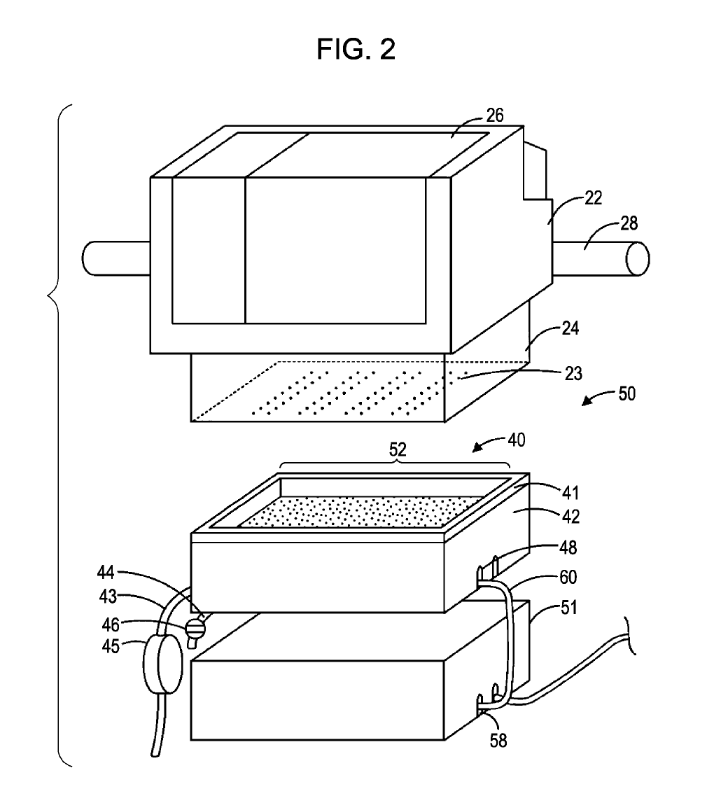

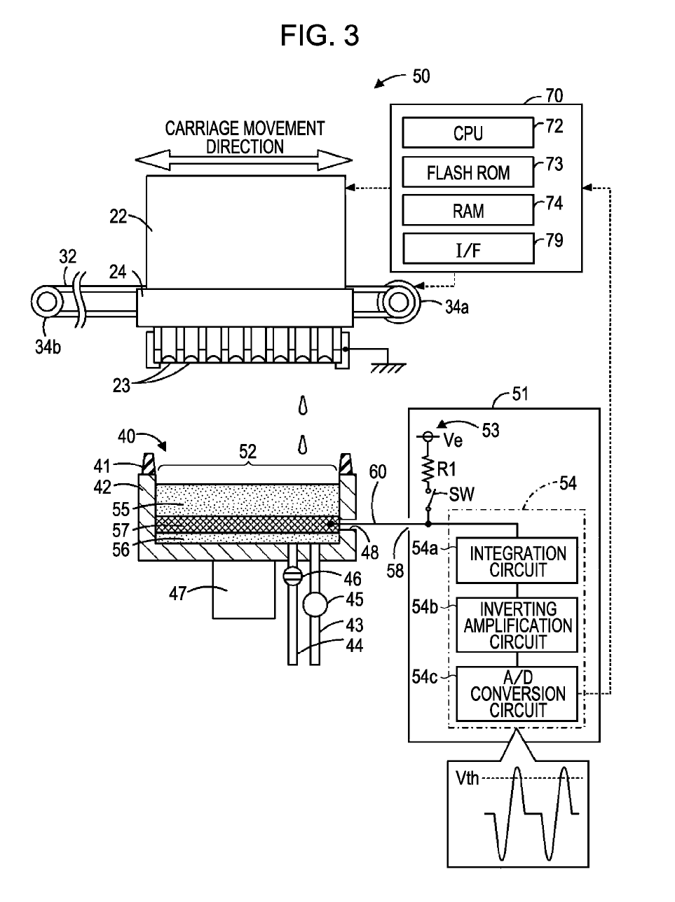

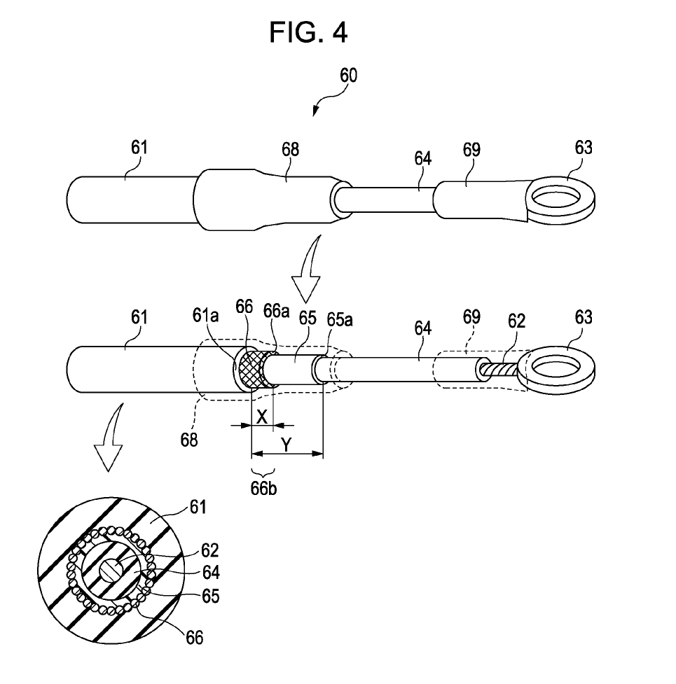

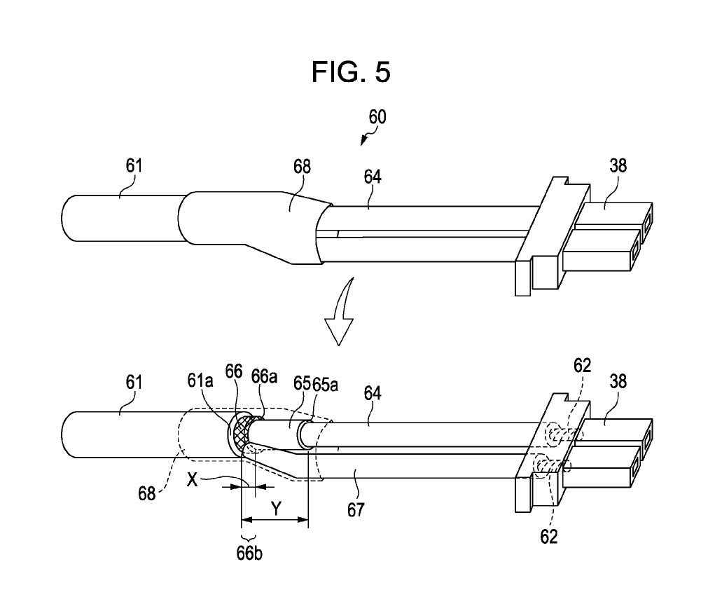

With reference to the accompanying drawings, an exemplary embodiment of the present invention will now be explained in detail. FIG. 1 is a diagram that schematically illustrates an example of the configuration of a printer 20 according to the present embodiment of the invention. FIG. 2 is a perspective view that schematically illustrates an example of the configuration of a nozzle inspection device 50. FIG. 3 is a block diagram that schematically illustrates an example of the configuration of the nozzle inspection device 50. FIG. 4 is a diagram that schematically illustrates an example of the structure of one end region of a shield cable 60. FIG. 5 is a diagram that schematically illustrates an example of the structure of the other end region of the shield cable 60. As illustrated in FIG. 1, the printer 20 according to the present embodiment of the invention is provided with a printing mechanism 21, a paper transport mechanism 30, a capping device 40, the nozzle inspection device 50, and a controller 70. The printing mechanism 21 includes a print head 24. The print head 24 discharges ink as a kind of fluid onto a sheet of recording paper S. The recording paper S is a kind of various target objects. The paper transport mechanism 30 transports the recording paper S. The capping device 40 seals the print head 24. In addition, the capping device 40 cleans the print head 24. The nozzle inspection device 50 tests whether ink is ejected from the print head 24 or not. The controller 70 controls the entire operation of the printer 20.

The printing mechanism 21 is provided with a carriage 22 and ink cartridges 26 besides the print head 24. A carriage belt 32 is attached to the carriage 22. The carriage 22 reciprocates in the leftward and rightward directions, that is, in the main-scan direction, along a carriage shaft 28. The ink cartridges 26 contain ink of respective colors. Ink contained in the ink cartridges 26 is supplied to the print head 24. The print head 24 utilizes pressure to eject ink of each color from nozzles 23. Ink is discharged in the form of drops. The carriage belt 32 is stretched between a carriage motor 34a and a driven roller 34b. The carriage motor 34a is fixed to the right side of a case 39. The driven roller is fixed to the left side of the case 39. The carriage motor 34a turns the carriage belt 32. The carriage 22 moves when the carriage belt 32 turns. A linear encoder 25, which detects the position of the carriage 22, is provided behind the carriage 22. Accordingly, the position of the carriage 22 can be controlled with the use of the linear encoder 25. The print head 24 is mounted on the bottom of the carriage 22. The print head 24 uses a piezoelectric deformation pressurization method for ejecting ink. Specifically, a voltage is applied to piezoelectric elements to deform the piezoelectric elements. The deformation of the piezoelectric elements pressurizes ink. Utilizing the pressure, the print head 24 discharges ink of each color from the nozzles 23, which are formed through the bottom face of the print head 24. The ink cartridges 26 are detachably attached to the carriage 22. Each ink cartridge 26 contains ink of the corresponding print color such as cyan (C), magenta (M), yellow (Y), black (K), or the like. Ink contains pigment or dye as colorant, which is dispersed in water. Water is a kind of solvent.

The paper transport mechanism 30 includes a paper transport roller 35, a feeding roller, and an ejecting roller. When driven by a driving motor 33, the paper transport roller 35 rotates to transport the recording paper S over a platen 29. The recording paper S is transported in a direction from the distal (i.e., far) side to the proximal (i.e., near) side in FIG. 1. The feeding roller feeds sheets of the recording paper S stacked on a feed tray (not shown) one after another toward the platen 29. The ejecting roller ejects the recording paper S onto which ink has been discharged over the platen 29 to an eject tray (not shown).

The capping device 40 includes a capping member 42 formed as a case, which has the shape of a substantially rectangular open-topped box. The capping case 42 is made of an insulating member. The capping device 40 is provided at the initial position (i.e., home position) of the carriage 22. A sealing member 41 is provided on the rim of the opening of the capping device 40. The sealing member 41 is made of an insulating material such as silicon rubber. An elevation mechanism 47 (refer to FIG. 3) supports the capping device 40. Accordingly, the capping device 40 can move upward and downward. The capping device 40 is used for cleaning the nozzles 23. In the cleaning, ink clogged in the nozzles 23 is removed by suction. In addition, the capping device 40 is used for sealing the nozzles 23. For example, the nozzles 23 are sealed during a pause in printing. The purpose of the sealing is to prevent the nozzles 23 from drying. A suction pump 45 is connected to the capping device 40 through a suction tube 43. An air open/close valve 46 is connected to the capping device 40 through an air tube 44. When the suction pump 45 operates in a valve-closed state, that is, when the air open/close valve 46 is closed, negative pressure is generated in a space inside the capping device 40. Due to the negative pressure generated when the capping device 40 seals the nozzles 23, ink clogged in the nozzles 23 is forcibly removed. The capping device 40 cleans the nozzles 23 in this way.

As illustrated in FIGS. 2 and 3, the nozzle inspection device 50 is provided with an inspection area 52, a voltage application circuit 53, and a voltage detection circuit 54. The inspection area 52 catches ink drops discharged from the nozzles 23 of the print head 24. The voltage application circuit 53 sets the potential of the inspection area 52 at a predetermined level so as to generate a predetermined potential difference between the print head 24 and the inspection area 52. The voltage detection circuit 54 detects a change in voltage that occurs at the inspection area 52. The inspection area 52 is formed in the capping device 40, which seals the print head 24. The inspection area 52 is a rectangular area. As illustrated in FIG. 3, an upper ink absorber 55, a lower ink absorber 56, and an electrode member 57 are layered at the inspection area 52. Ink drops land on the upper ink absorber 55. After the landing, ink infiltrates down into the lower ink absorber 56 through the electrode member 57. The lower ink absorber 56 absorbs the ink. The electrode member 57, which is sandwiched between the upper ink absorber 55 and the lower ink absorber 56, has a mesh structure. The upper ink absorber 55 is made of sponge that has electric conductivity. The potential of the upper ink absorber 55 is the same as that of the electrode member 57. The exposed surface of the upper ink absorber 55 is the inspection area 52. The sponge has high liquid permeability. Accordingly, ink drops that have landed on the upper ink absorber 55 moves downward quickly. Ester urethane sponge is used as the material of the upper ink absorber 55 in this example. The lower ink absorber 56 has higher retentivity, that is, ink-holding property, than that of the upper ink absorber 55. For example, the lower ink absorber 56 is made of non-woven fabric such as felt. The electrode member 57 is a lattice mesh member that is made of metal such as stainless (e.g., SUS). Ink that has been temporarily absorbed by the upper ink absorber 55 sinks through the meshes of the grid electrode member 57 into the lower ink absorber 56. Then, the lower ink absorber 56 absorbs the ink. Since the electrode member 57 is in contact with the upper ink absorber 55, which has electric conductivity, the potential of the surface of the upper ink absorber 55 is the same as that of the electrode member 57. In other words, the potential of the inspection area 52 is the same as that of the electrode member 57.

The voltage application circuit 53 is electrically connected to the electrode member 57 provided at the inspection area 52. A boosting circuit, which is not illustrated in the drawing, raises the voltage level of electric wiring that is routed inside the printer 20 from several volts to several tens of volts or to several hundred volts. The voltage application circuit 53 applies boosted direct-current voltage Ve (e.g., 400V) to the inspection area 52 via a resistance element R1 (e.g., 1MΩ) and a switch SW. The voltage detection circuit 54 is also electrically connected to the electrode member 57 provided at the inspection area 52. When ink is ejected from the print head 24 and then lands on the inspection area 52, a voltage level changes at the inspection area 52. The voltage detection circuit 54 detects the voltage change at the inspection area 52. The voltage detection circuit 54 includes an integration circuit 54a that integrates a voltage signal of the print head 24 to output an integration result, an inverting amplification circuit 54b that performs inverting amplification on the output signal of the integration circuit 54a to output an inverting amplification result, and an analog-to-digital (A/D) conversion circuit 54c that performs A/D conversion on the output signal of the inverting amplification circuit 54b to output an A/D conversion result to the controller 70. A change in voltage that occurs as a result of the movement of a single drop of ink in the air and its landing is very subtle. Therefore, the integration circuit 54a calculates an integrated value of the voltage change on the basis of the movement of plural drops of ink discharged from the same nozzle 23 in the air and the landing thereof, thereby outputting the integration result as a large voltage change. The inverting amplification circuit 54b inverts the polarity (i.e., positive and negative) of the voltage change. In addition, the inverting amplification circuit 54b amplifies the signal outputted from the integration circuit 54a with a predetermined amplification factor and then outputs the amplified signal. The predetermined amplification factor is determined on the basis of its circuit configuration. The A/D conversion circuit 54c converts the signal outputted from the inverting amplification circuit 54b, which is an analog signal, into a digital signal and then outputs the A/D converted signal to the controller 70.

The voltage application circuit 53 and the voltage detection circuit 54 are encased in a circuit case 51. The inside of the circuit case 51 is shielded. The circuit case 51 has a slit hole 58. The capping member 42 also has a slit hole 48. The voltage application circuit 53 and the voltage detection circuit 54 are electrically connected to the electrode member 57 through the shield cable 60, which passes through the slit holes 58 and 48 (refer to FIG. 2). As illustrated in FIGS. 4 and 5, the shield cable 60 includes a central conductor 62, an insulating layer 64, a conductive resin layer 65, a peripheral conductor (i.e., circumferential conductor) 66, and a jacket 61. The central conductor 62 is a metal conductor to which the direct-current voltage Ve is applied. The insulating layer 64 substantially covers the central conductor 62. The conductive resin layer 65, which has electric conductivity, is provided on the outer surface of the insulating layer 64 (and thus substantially covers the insulating layer 64). The peripheral conductor 66 is a metal conductor that is connected to a ground. The peripheral conductor 66 is provided on the outer surface of the conductive resin layer 65. The jacket 61 is provided as an exposed cover layer on the outer surface of the peripheral conductor 66. The shield cable 60 is a coaxial cable whose central axis is the central conductor 62. As viewed from the central axis toward the outer circumference of the shield cable 60, the insulating layer 64, the conductive resin layer 65, the peripheral conductor 66, and the jacket 61 are formed around the central conductor 62 in the order of appearance herein. The direct-current voltage Ve supplied from the voltage application circuit 53 is applied to the electrode member 57 through the shield cable 60. In addition, an electric change that occurs at the inspection area 52 is communicated to the voltage detection circuit 54 through the shield cable 60. The jacket 61 is the outermost cover member. The jacket 61 is made of a high polymeric material that has a high mechanical strength and a high insulating property. The central conductor 62 is made of conductive metal such as copper or the like. The insulating layer 64 is made of insulating resin. For example, the insulating layer 64 is made of polyester or polyurethane. The peripheral conductor 66 is a conductor that is provided on and around the conductive resin layer 65 and is made up of a number of conductive wires woven in a mesh structure. The conductive resin layer 65 is made of a conductive resin material that has excellent adherence to the insulating layer 64. For example, the conductive resin layer 65 is made of polyacethylene. In addition, the conductive resin layer 65 offers good contact with each of the conductive wires woven in a mesh structure, which make up the peripheral conductor 66. The shield cable 60 is subjected to outer-layer-removal working to partially expose inner layers to the outside. An insulating cover member 68 is attached to a part of the shield cable 60 at which at least the peripheral conductor 66 would be partially exposed to the outside if not covered by the insulating cover member 68. The insulating cover member 68 is attached thereto in a subsequent separate step in order to cover the exposed part. The insulating cover member 68 prevents the part from electrically contacting with any external member or the like. In like manner, an insulating cover member 69 is attached to a part of the shield cable 60 at which the central conductor 62 would be partially exposed to the outside if not covered by the insulating cover member 69. The insulating cover member 69 is attached thereto in a subsequent separate step in order to cover the exposed part. The insulating cover member 69 prevents the part from electrically contacting with any external member or the like. That is, at each end region of the shield cable 60, the outer-layer members are partially removed so that the central conductor 62, the insulating layer 64, the conductive resin layer 65, and the peripheral conductor 66 are not covered by the jacket 61 and thus partially exposed to the outside.

As illustrated in FIG. 4, a fixation metal member (e.g., ring) 63 is connected to the central conductor 62 at one end of the shield cable 60. The fixation metal member 63 is fixed to the electrode member 57 with a small screw. The peripheral conductor 66 is terminally removed at one end region of the shield cable 60 to form a conductor end 66a as the cut rim of the peripheral conductor 66. The cut rim constitutes the end of the exposed part of the peripheral conductor 66, which is the part that is not covered by the jacket 61. The exposed part of the peripheral conductor 66 may be hereinafter referred to as a “peeled-off bare part” 66b, which is an example of a separation portion according to an aspect of the invention. At this one end region of the shield cable 60, the partial length Y of the conductive resin layer 65 from an end 61a of the jacket 61 to a resin end 65a of the conductive resin layer 65, which is the tip of the conductive resin layer 65 at this end, is greater than the partial length X of the peripheral conductor 66 from the jacket end 61a to the conductor end 66a of the peripheral conductor 66, which is the tip of the peripheral conductor 66 at this end. That is, the conductive resin layer 65 has the partial length Y that is greater than the length of the peeled-off bare part 66b measured from the jacket end 61a in the direction of the length of the shield cable 60. Accordingly, the conductive resin layer 65 is inevitably (i.e., always) provided between the peripheral conductor 66 made up of meshed conductive wires and the insulating layer 64. Because of such a structure, for example, static electricity or the like that is generated near the peeled-off bare part 66b is easily removed by means of the conductive resin layer 65.

As illustrated in FIG. 5, a connector 38 is fixed to the other end of the shield cable 60. The connector 38 is inserted in a receptacle of a circuit board on which the voltage application circuit 53 and other circuitry are provided. At the other end region of the shield cable 60, a branch extension part of the peripheral conductor 66 extends from the peeled-off bare part 66b to the connector 38. An insulator formation layer 67 is provided on the extension part of the peripheral conductor 66 and thus covers the part. As in the structure of the one end region of the shield cable 60 explained above, at this other end region of the shield cable 60, the partial length Y of the conductive resin layer 65 from the jacket end 61a to the resin end 65a is greater than the partial length X of the peripheral conductor 66 from the jacket end 61a to the conductor end 66a. That is, the conductive resin layer 65 has the partial length Y that is greater than the length of the peeled-off bare part 66b measured from the jacket end 61a in the direction of the length of the shield cable 60. Accordingly, the conductive resin layer 65 is inevitably provided between the exposed peripheral conductor 66 and the insulating layer 64. Because of such a structure, for example, static electricity or the like that is generated near the peeled-off bare part 66b is easily removed by means of the conductive resin layer 65.

The controller 70 is a microprocessor that includes a CPU 72 as a central processor. As illustrated in FIG. 1, the controller 70 is provided with a flash ROM 73, a RAM 74, and an interface (I/F) 79 besides the CPU 72. The flash ROM 73 is a data-rewritable ROM that memorizes various processing programs. The RAM 74 temporarily memorizes data or stores data. The I/F 79 is used for exchanging data with external devices such as a user personal computer (PC) 12 and the like. The various processing programs memorized in the flash ROM 73 include a nozzle inspection routine, a cleaning routine, and the like. The RAM 74 has a buffer space for printing. A print job and the like, which are sent from an external device such as the user PC 12 or the like via the I/F 79, are stored in the print buffer space. A voltage signal outputted from the voltage detection circuit 54 of the nozzle inspection device 50 is inputted into the controller 70 through an input port, which is not illustrated in the drawing. In addition, a print job and the like outputted from the external devices (e.g., the user PC 12) are inputted into the controller 70 through the I/F 79. The controller 70 outputs a signal for controlling the print head 24, a signal for controlling the nozzle inspection device 50, a signal for driving the carriage motor 34a, and the like through an output port, which is not illustrated in the drawing.

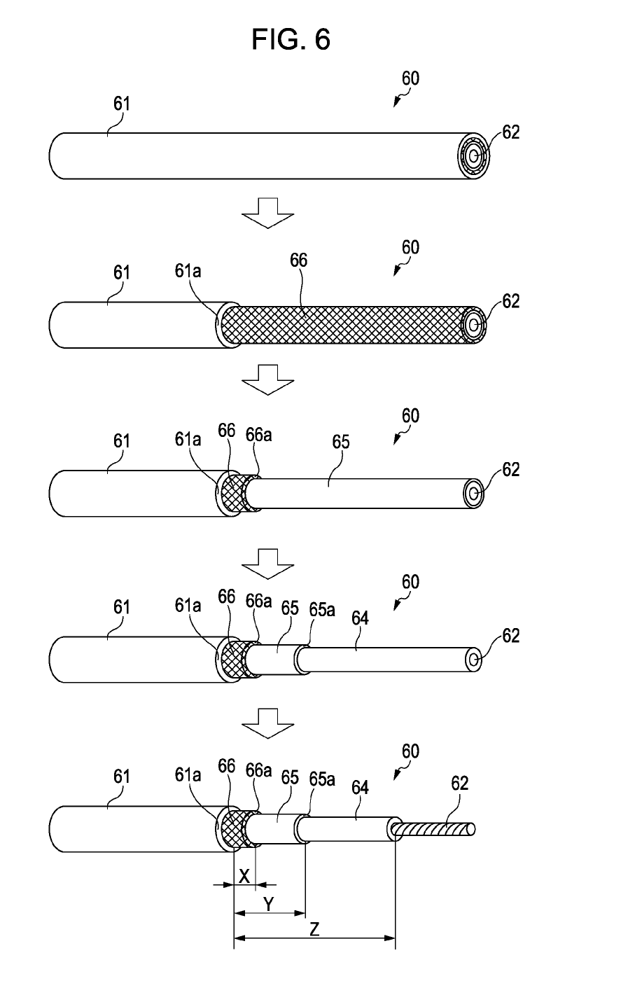

Next, the working of the end regions of the shield cable 60 is explained below. FIG. 6 is a diagram that schematically illustrates an example of the working of an end region of the shield cable 60. In this paragraph, cable-end working that includes the cutting of the peripheral conductor 66 to form the conductor end 66a (refer to FIG. 4) is explained. As a first step, a front-end region of the jacket 61 (which is shown in the uppermost one in a set of five process drawings in FIG. 6) is removed. The front-end region has a predetermined length measured from the front end of the shield cable 60. As a result, a front-end region of the peripheral conductor 66 is exposed to the outside (refer to the second drawing from the top). The front-end region of the peripheral conductor 66 is a region from the jacket end 61a to the front end of the shield cable 60. Next, the exposed peripheral conductor 66 is partially cut off while leaving a shortened exposed part that has the predetermined length X measured from the jacket end 61a. For example, the length of the left exposed part is 5 mm. As a result, the conductor end 66a is formed at a distance equal to the predetermined length X from the jacket end 61a. At the same time, a front-end region of the conductive resin layer 65 is exposed to the outside (refer to the third drawing from the top). The front-end region of the conductive resin layer 65 is a region from the conductor end 66a to the front end of the shield cable 60. Next, the exposed conductive resin layer 65 is partially cut off while leaving a part that has the predetermined length Y measured from the jacket end 61a (refer to the fourth drawing from the top). The length of the left part from the jacket end 61a to the cut end is greater than the length from the jacket end 61a to the conductor end 66a. For example, the length of the left part is 10 mm. As a result, the resin end 65a is formed at a distance equal to the predetermined length Y from the jacket end 61a. At the same time, a front-end region of the insulating layer 64 is exposed to the outside (refer to the fourth drawing from the top, again). The front-end region of the insulating layer 64 is a region from the resin end 65a to the front end of the shield cable 60. Then, the exposed insulating layer 64 is partially cut off while leaving a part that has a predetermined length Z measured from the jacket end 61a to the cut end. As a result, a front-end region of the central conductor 62 is exposed to the outside (refer to the fifth drawing from the top). Thereafter, as illustrated in FIG. 4, the fixation metal member 63 is fixed to the central conductor 62. In addition, the cover members 68 and 69 are attached to the exposed parts of the respective conductors. As explained above, the shield cable 60 is worked through a series of processes that includes a process of terminally removing the conductive resin layer 65 and the jacket 61 (and the peripheral conductor 66) from a front end region of the shield cable 60 in such a manner that the conductive resin layer 65 from the jacket end 61a to its cut end is longer than the peeled-off bare part 66b measured in the direction of the length of the shield cable 60. The peeled-off bare part 66b is an exposed regional part of the peripheral conductor 66 where the jacket 61 does not cover the peripheral conductor 66. The length of the exposed regional part of the conductive resin layer 65 where the peripheral conductor 66 does not cover the conductive resin layer 65, that is, a part from the conductor end 66a to the cut end of the conductive resin layer 65, is not limited to any specific length herein as long as it is great enough to suppress discharge noise. It is preferable that, however, the exposed part of the conductive resin layer 65 should have the length of 3 mm or longer. The length of the exposed part of the conductive resin layer 65 can be expressed as (Y−X). With such preferable length, it is possible to suppress discharge noise effectively. On the other hand, it is not necessary for the length (Y−X) to be greater than 5 mm because extra length does not contribute to effective suppression.

Next, the operation of the nozzle inspection device 50 is explained below. When nozzle inspection processing is initiated, the CPU 72 turns the switch SW ON to cause the voltage application circuit 53 to apply the direct-current voltage Ve to the inspection area 52 through the shield cable 60. Upon the application of the direct-current voltage Ve to the inspection area 52, a predetermined potential difference occurs between ink held at the nozzles 23 and the inspection area 52. Next, the CPU 72 causes the print head 24 to discharge ink drops from the nozzles 23 onto the inspection area 52 in a predetermined sequential order. The principle of nozzle inspection is explained here. A discharging experiment was conducted with the print head 24 being set at ground potential to cause a potential difference between the print head 24 and the inspection area 52. Ink drops were discharged from the nozzles 23 under such potential condition. As the result of the experiment, a sine curve appeared as the waveform of an output signal at the inspection area 52. Though the theoretical explanation of the appearance of an output signal having such a waveform is not given here, it is inferred to be attributable to the flowing of an induction current due to electrostatic induction as charged ink droplets approach the inspection area 52. In addition, the following was found as the result of the experiment. The amplitude of a signal outputted from the voltage detection circuit 54 increased as the distance from the print head 24 to the inspection area 52 decreased. The amplitude of a signal outputted from the voltage detection circuit 54 increased as the discharge size of an ink drop increased. The amplitude in the waveform of an output signal is smaller than an ordinary level or could be reduced to approximately zero when no ink drop is discharged due to the clogging of the nozzle 23 or when the size of an ink drop is smaller than a predetermined size. Therefore, it is possible to judge whether the nozzle 23 is clogged or not on the basis of the amplitude in the waveform of an output signal, that is, whether the level is lower than a predetermined threshold value Vth or not (refer to FIG. 3). Even when an ink drop has a predetermined size, the amplitude in the waveform of an output signal for a single drop of ink is very weak. For this reason, more than one drop is discharged for judgment. For example, an ink drop having a large dot size is discharged eight times consecutively. In addition, the inverting amplification circuit 54b performs signal amplification. Accordingly, an integrated value for plural drops of ink is outputted. Therefore, the waveform of an output signal that is sufficiently large in amplitude can be obtained from the voltage detection circuit 54. The number of ink drops discharged can be arbitrarily set so as to ensure high inspection accuracy. In addition, the threshold value Vth can be empirically set so as to ensure accurate judgment as to whether ink drops are discharged or not. The CPU 72 judges that each nozzle 23 whose level in the acquired waveform of an output signal is lower than the threshold value Vth is clogged. Then, the CPU 72 causes the RAM 74 to memorize the nozzle-clog information. When there is any nozzle that is clogged, the clogged nozzle is cleaned by means of the capping device 40.

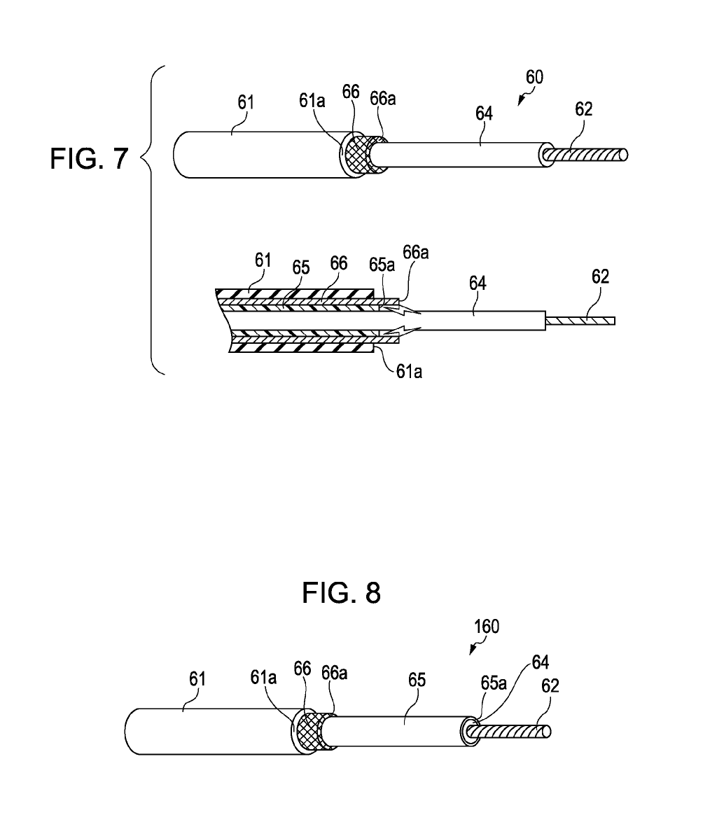

A signal whose output waveform is detected at the voltage detection circuit 54 is inputted into the voltage detection circuit 54 through the shield cable 60. For this reason, it is preferable to make noise that occurs in the shield cable 60 as small as possible in terms of detection accuracy. FIG. 7 is a diagram that schematically illustrates an example of the structure of the shield cable 60 that includes the conductive resin layer 65 that is shorter than the peripheral conductor 66. As illustrated in FIG. 7, electrostatic discharge noise could be generated if there is a regional part where the conductive resin layer 65 is not formed at all between the insulating layer 64 and the peripheral conductor 66 in a front-end region of the shield cable 60. Erroneous detection in nozzle inspection might occur due to the electrostatic discharge noise. That is, there is a possibility of erroneous judgment in nozzle inspection when no ink drop is actually discharged. In contrast, in the structure of the shield cable 60 according to the present embodiment of the invention, the conductive resin layer 65 from the jacket end 61a to its cut end is longer than the peeled-off bare part 66b. By this means, electrostatic discharge noise and the like at the cable end can be suppressed. In addition, static noise and the like inside the cable can be suppressed because the conductive resin layer 65 is provided.

In this paragraph, the corresponding relationships between components/units described in the present embodiment of the invention and constituent elements according to an aspect of the invention are explained. The print head 24 described in the present embodiment of the invention corresponds to a discharging head according to an aspect of the invention. A combination of the inspection area 52, the voltage application circuit 53, and the voltage detection circuit 54 corresponds to a detecting section according to an aspect of the invention. The inspection area 52 corresponds to a fluid reception area according to an aspect of the invention. The inverting amplification circuit 54b corresponds to an amplifying circuit according to an aspect of the invention. Ink described in the present embodiment of the invention corresponds to fluid according to an aspect of the invention. A sheet of recording paper S corresponds to a target according to an aspect of the invention. The corresponding relationships for the shield cable 60 are as follows. The jacket 61 corresponds to a cover layer according to an aspect of the invention. The central conductor 62 corresponds to a first conductor according to an aspect of the invention. The peripheral conductor 66 corresponds to a second conductor according to an aspect of the invention. The insulating layer 64 corresponds to an insulating layer according to an aspect of the invention. The conductive resin layer 65 corresponds to a conductive layer according to an aspect of the invention. Finally, the insulator formation layer 67 corresponds to an insulator formation layer according to an aspect of the invention.

The nozzle inspection device 50 according to the present embodiment of the invention explained in detail above offers the following advantages. Since the conductive resin layer 65 is provided between the peripheral conductor 66 and the insulating layer 64, for example, static electricity that is generated at the peripheral conductor 66 can be quickly removed by means of the conductive resin layer 65. Therefore, it is possible to suppress inner noise that occurs inside the cable. In addition, the jacket-end-to-resin-end part of the conductive resin layer 65 is longer than the peeled-off bare part 66b, which is an exposed regional part of the peripheral conductor 66 where the jacket 61 does not cover the peripheral conductor 66, as measured in the direction of the length of the shield cable 60. Therefore, the conductive resin layer 65 having such a greater length absorbs electrostatic discharge, which would be generated if the exposed peripheral conductor 66 and the insulating layer 64 were provided opposite each other, thereby achieving discharge suppression. Since noise is suppressed, nozzle inspection can be conducted with high inspection accuracy. The conductive resin layer 65 is made of a conductive resin material that has excellent adherence to the insulating layer 64. The adherence to the insulating layer 64 is greater than that to a metal conductor. Thus, it is easier to suppress noise. The nozzle inspection device 50 is provided with the inverting amplification circuit 54b. The nozzle inspection device 50 is capable of suppressing noise amplification that occurs due to the amplification of an electric change at the inspection area 52. Thus, it is possible to conduct fluid discharge inspection with high inspection accuracy. Moreover, since the insulator formation layer 67 is provided on a part of the peripheral conductor 66 that extends from the peeled-off bare part 66b, the exposed conductive resin layer 65 can be shortened. Therefore, it is possible to suppress noise that could occur at the exposed peripheral conductor 66, thereby conducting nozzle inspection with high inspection accuracy. Furthermore, since nozzle inspection is conducted by detecting an electric change that occurs when ink lands on the inspection area 52, it is possible to conduct discharge inspection easily.

Needless to say, the invention is not restricted to an exemplary embodiment described above. That is, the invention may be configured or implemented in a variety of modifications without departing from the gist and the spirit thereof, which is encompassed within the technical scope thereof.

In the structure of the shield cable 60 according to the foregoing embodiment of the invention, the insulating layer 64 is longer than the conductive resin layer 65. Notwithstanding the foregoing, however, the length of the insulating layer 64 may be equal to that of the conductive resin layer 65 as illustrated in FIG. 8. Even with such a modified structure, it is possible to suppress electrostatic discharge that would be generated if the exposed peripheral conductor 66 and the insulating layer 64 were provided opposite each other. Thus, nozzle inspection can be conducted with high inspection accuracy.

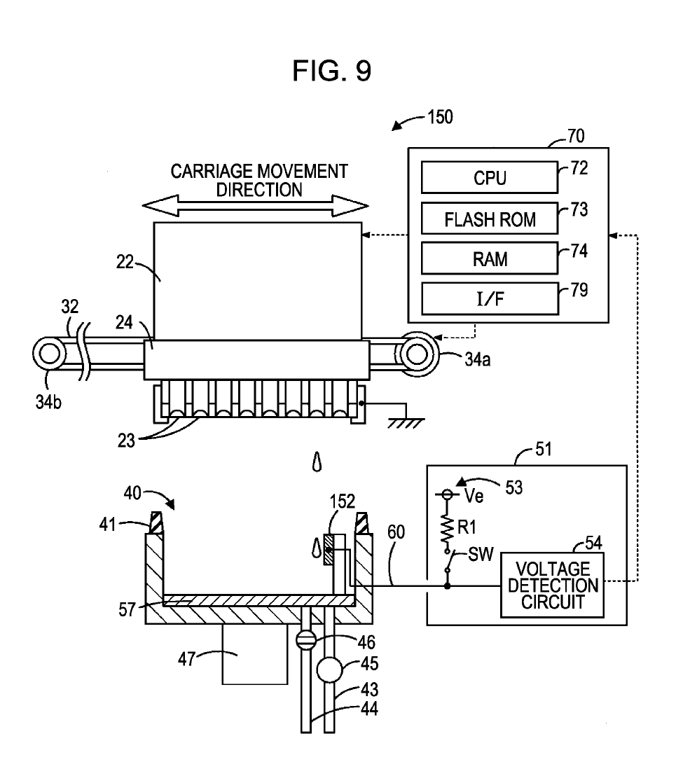

In the configuration of the nozzle inspection device 50 according to the foregoing embodiment of the invention, the voltage detection circuit 54 detects an electric change that occurs when ink lands on the inspection area 52. However, the scope of the invention is not limited to such an exemplary configuration. For example, the configuration may be modified as illustrated in FIG. 9. A modified nozzle inspection device 150 is provided with a detecting member 152. The detecting member 152 is provided in the neighborhood of an ink-passing position where ink ejected from the print head 24 passes. The detecting member 152 detects an electric change that occurs when the ejected ink passes through the neighborhood of the detecting member 152. The nozzle inspection device 150 detects an ink-discharging state on the basis of the result of detection of the electric change. FIG. 9 is a block diagram that schematically illustrates an example of the configuration of the nozzle inspection device 150. In this configuration, the shield cable 60 is connected to the detecting member 152. Accordingly, the direct-current voltage Ve is applied to the detecting member 152 through the shield cable 60. In addition, an electric change that is detected by the detecting member 152 is communicated through the shield cable 60. Since the detecting member 152 detects an electric change that occurs when ink passes through the neighborhood of the detecting member 152, it is possible to conduct nozzle inspection with comparative ease. The detecting member 152 can be configured as any member that is capable of detecting an electric change that occurs when ink passes through the neighborhood of the detecting member 152. For example, the detecting member 152 may be configured as an electrode plate, an electric line, or the like.

The nozzle inspection device 50 according to the foregoing embodiment of the invention applies a voltage to the inspection area 52 so as to generate a predetermined potential difference between the print head 24 and the inspection area 52. However, the scope of the invention is not limited to such an exemplary configuration. For example, the inspection area 52 may be connected to a ground. A voltage may be applied to the print head 24. Accordingly, a predetermined potential difference is generated between the voltage-applied print head 24 and the grounded inspection area 52. Even with such modification, it is possible to detect a waveform at the voltage detection circuit 54 when ink drops are discharged from the print head 24. In the configuration of the nozzle inspection device 50 according to the foregoing embodiment of the invention, the voltage detection circuit 54 is connected to the inspection area 52 so as to detect an electric change that occurs due to the discharging of ink drops. However, the scope of the invention is not limited to such an exemplary configuration. For example, the voltage detection circuit 54 may be connected to the print head 24 with the electrode member 57 of the capping device 40 being connected to a ground to detect an electric change that occurs due to the discharging of ink drops. The voltage level (i.e., potential) of an electrode that is connected to a ground is not limited to a ground level. The voltage level of the electrode may be any level that is different from the level of a voltage applied by the voltage application circuit 53 and causes a predetermined level difference (i.e., a predetermined potential difference) between the voltage of the electrode and that of the voltage application circuit 53. Even with such modification, it is possible to detect a waveform at the voltage detection circuit 54 when ink drops are discharged from the print head 24. The electrode that applies a predetermined potential at the print head 24 may be any type of electrode that is conductive to ink retained in the print head 24 so as to apply a potential to the ink. For example, the electrode may be a nozzle plate. Or, the electrode may be provided inside the head. In the configuration illustrated in FIG. 3, both the voltage application circuit 53 and the voltage detection circuit 54 are connected to the inspection area 52. As a modification example, it is explained above that both the voltage application circuit 53 and the voltage detection circuit 54 may be connected to the print head 24. The scope of the invention is not limited to these examples. For example, the voltage application circuit 53/voltage detection circuit 54 may be cable-connected to the print head 24 or the inspection area 52 separately. In any of these four connection patterns, it is possible to detect a waveform at the voltage detection circuit 54 when ink drops are discharged from the print head 24 and to suppress noise at the shield cable 60.

In the foregoing embodiment of the invention, it is explained that the inspection area 52 is provided inside the capping device 40. However, the scope of the invention is not limited to such an exemplary configuration. For example, the inspection area 52 may be provided in a flushing area where ink drops are discharged regardless of print data either periodically or at predetermined time intervals for the purpose of preventing the viscosity of ink from increasing due to drying. Or, the inspection area 52 may be provided in other area within the movable range of the print head 24.

In the foregoing embodiment of the invention, it is explained that the inverting amplification circuit 54b amplifies the waveform of an output signal. However, the scope of the invention is not limited to such an exemplary configuration. For example, the inverting amplification circuit 54b may be omitted. Even with such a modified configuration, it is possible to reduce noise to conduct nozzle inspection with high inspection accuracy.

In the foregoing embodiment of the invention, it is explained that the direct-current voltage Ve is applied to the electrode member 57 through the shield cable 60. In addition, it is explained that an electric change that occurs at the inspection area 52 is communicated through the shield cable 60. That is, the same cable is used for voltage application and electric change communication. However, the scope of the invention is not limited to such an exemplary configuration. For example, a cable that is used for applying the direct-current voltage Ve to the electrode member 57 and another cable that is used for communicating an electric change that occurs at the inspection area 52 may be provided as two separate cables. In addition, the shield cable 60 is not limited to a coaxial cable. For example, the shield cable 60 may be a flat cable that includes layers of the central conductor 62, the insulating layer 64, and the conductive resin layer 65, and the peripheral conductor 66.

In the foregoing embodiment of the invention, it is explained that the print head 24 applies a voltage to each piezoelectric element to deform the piezoelectric elements. Ink is pressurized due to the deformation of the piezoelectric elements. However, the scope of the invention is not limited to such an exemplary pressurizing scheme. For example, a thermal pressurizing scheme may be adopted. In the thermal pressurizing scheme, a voltage is applied to an exothermic body such as a heater or the like to heat ink. Air bubbles are produced when the ink is heated. In this way, the ink can be pressurized. In the foregoing embodiment of the invention, it is explained that the ink cartridges 26 are detachably attached to the carriage 22, which reciprocates. That is, a so-called on-carriage configuration is explained. However, the scope of the invention is not limited to such an exemplary configuration. For example, the ink cartridges 26 may be detachably attached to the case 39, which is a so-called off-carriage configuration. In the off-carriage configuration, ink is supplied to the print head 24 through tubes. In the foregoing embodiment of the invention, it is explained that the printing mechanism 21 is provided with the carriage 22, which moves in the carriage movement direction. However, the scope of the invention is not limited to such an exemplary configuration. For example, the printing mechanism 21 may be provided with a so-called line ink-jet head, which has nozzle lines for respective colors. The nozzle lines of the line head extend in the direction of the width of a sheet of recording paper S.

The printer 20 that ejects ink onto the recording paper S is taken as an example in the foregoing embodiment of the invention. However, the scope of the invention is not limited to the printer 20. The invention can be applied to various kinds of discharge inspection apparatuses that can detect (i.e., inspect) whether fluid is discharged from nozzles or not by generating a potential difference between the print head 24 and the inspection area 52 and various kinds of fluid discharging apparatuses. For example, the invention is applicable to a printing apparatus that discharges other kind of liquid or a liquid/liquefied matter/material that is made as a result of dispersion of particles of functional material(s) in liquid (i.e., dispersion liquid). As another example, the invention is applicable to a printing apparatus that discharges gel or other gel-type fluid. The invention is applicable to a printing apparatus that discharges other substance such as a solid substance that can be discharged as a fluid. The invention is applicable to a liquid discharging apparatus that discharges liquid in which, for example, a material such as an electrode material, a color material, or the like that is used in the production of a liquid crystal display device, an organic electroluminescence (EL) display device, a surface/plane emission display device, a color filter, or the like is dissolved. The invention is applicable to a liquid discharging apparatus that discharges liquid in which such a material is dispersed. The invention is applicable to a liquid discharging apparatus that is used as a high precision pipette and discharges liquid as a sample. In addition, the invention is applicable to a liquid discharging apparatus that discharges liquid of a transparent resin such as an ultraviolet ray curing resin or the like onto a substrate so as to form a micro hemispherical lens (optical lens) that is used in an optical communication element or the like. The invention is applicable to a dry-jet type (i.e., powder-ejecting type) recording apparatus that discharges various kinds of powder or a granular matter/material such as toner or the like.

Though the printer 20 is taken as an example of a fluid discharging apparatus according to an aspect of the invention, the fluid discharging apparatus is not limited to the printer 20. For example, the fluid discharging apparatus may be embodied as a multi-function printer that is provided with a scanning unit for reading an original document. The fluid discharging apparatus may be embodied as a facsimile machine having a facsimile function. The concept of the invention encompasses a discharge inspection apparatus and a method for working a shield cable as some aspects thereof besides a fluid discharging apparatus. Thus, besides the printer 20, the invention can be embodied as the nozzle inspection device 50 and/or a method for working the shield cable 60 as disclosed herein.

The entire disclosure of Japanese Patent Application No. 2008-332605, filed Dec. 26, 2008 is expressly incorporated by reference herein.

What is claimed is:

1. A discharge inspection apparatus for inspecting a fluid discharge state of a discharging head through application of a voltage, the discharging head including a plurality of nozzles and discharging fluid from the nozzles onto a target, the apparatus comprising:
a detecting section that detects an electric change that occurs when the fluid is discharged from the discharging head; and
a shield cable including
a first conductor that is made of metal, a first voltage being applied to the first conductor,
an insulating layer that substantially covers the first conductor,
a conductive layer that has conductivity, the conductive layer being provided on an outer surface of the insulating layer,
a second conductor that is made of metal and is provided on an outer surface of the conductive layer, a second voltage being applied to the second conductor, the second voltage being lower in level than the first voltage, and
a cover layer that is provided on an outer surface of the second conductor,
wherein the conductive layer measured from an end of the cover layer in a direction of the length of the cable is longer than a separation portion, which is an exposed part of the second conductor where the cover layer does not cover the second conductor, and
the shield cable is connected to at least either the detecting section or the discharging head.

2. The discharge inspection apparatus according to claim 1, wherein the shield cable is a coaxial cable whose central axis is the first conductor; and the insulating layer, the conductive layer, the second conductor, and the cover layer are formed around the first conductor in the order of appearance herein as viewed toward the outer circumference of the shield cable.

3. The discharge inspection apparatus according to claim 1, wherein the detecting section includes an amplifying circuit that amplifies the electric change; and the electric change that occurs when the fluid is discharged is communicated through the shield cable.

4. The discharge inspection apparatus according to claim 1, wherein an insulator formation layer is provided on a part of the second conductor that extends from the separation portion.

5. The discharge inspection apparatus according to claim 1, wherein the detecting section includes a fluid reception area where the fluid discharged from the discharging head is received; the detecting section detects the electric change that occurs due to landing of the discharged fluid on the fluid reception area so as to detect the fluid discharge state on the basis of the result of detection of the electric change; the shield cable is connected to the fluid reception area; the first voltage is applied to the fluid reception area through the shield cable; and the electric change at the fluid reception area is communicated through the shield cable.

6. The discharge inspection apparatus according to claim 1, wherein the detecting section includes a detecting member that is provided in a neighborhood of a position where the fluid discharged from the discharging head passes; the detecting section detects the electric change that occurs when the discharged fluid passes through the position near the detecting member so as to detect the fluid discharge state on the basis of the result of detection of the electric change; the shield cable is connected to the detecting member; the first voltage is applied to the detecting member through the shield cable; and the electric change detected by the detecting member is communicated through the shield cable.

7. The discharge inspection apparatus according to claim 1, wherein the length of a relatively long part of the conductive layer, which is measured from an end of the second conductor in the direction of the length of the cable, is 3 mm or greater.

8. A fluid discharging apparatus comprising: the discharge inspection apparatus according to claim 1; and a discharging head that discharges the fluid.

9. A method for working a shield cable that includes a first conductor that is made of metal, a first voltage being applied to the first conductor, an insulating layer that substantially covers the first conductor, a conductive layer that has conductivity, the conductive layer being provided on an outer surface of the insulating layer, a second conductor that is made of metal and is provided on an outer surface of the conductive layer, a second voltage being applied to the second conductor, the second voltage being lower in level than the first voltage, and a cover layer that is provided on an outer surface of the second conductor, the shield cable being connected to a discharge inspection apparatus for inspecting a fluid discharge state of a discharging head through application of a voltage, the discharging head including a plurality of nozzles and discharging fluid from the nozzles onto a target, the discharge inspection apparatus conducting inspection by detecting an electric change that occurs when the fluid is discharged, the method comprising:
partially removing the cover layer from a front end region of the shield cable; and
partially removing the conductive layer from the front end region of the shield cable,
wherein the cover layer and the conductive layer are partially removed in such a manner that the conductive layer measured from an end of the cover layer in a direction of the length of the cable is longer than a separation portion, which is an exposed part of the second conductor where the cover layer does not cover the second conductor.
